(19) United States
(12) Patent Application Publication
(10) Pub. No.: US 2025/0300399 A1
(43) Pub. Date: Sep. 25, 2025

(54) Electrical Connector Joining Component Assembly and Electrical Connector Thereof

(71) Applicants: Dongguan Tarng Yu Electronics Co., Ltd., Dongguan City (CN); Tarng Yu Enterprise co., ltd., New Taipei City (TW)

(72) Inventors: YING-CHUNG CHEN, New Taipei City (TW); MU-JUNG HUANG, New Taipei City (TW)

(21) Appl. No.: 19/086,658

(22) Filed: Mar. 21, 2025

(30) Foreign Application Priority Data
Mar. 22, 2024 (TW) 113110911

(51) Int. Cl. H01R 13/629

(52) U.S. Cl. CPC H01R 13/629

(57) ABSTRACT

An electrical connector joining component assembly and electrical connector thereof, wherein the electrical connector is joined with a joining component and comprises a joining observation structure. During the process in which the electrical connector is joined with the joining component, the joining observation structure allows for visual observation of the joining component, thereby enabling real-time adjustment of the electrical connector's position to ensure alignment with the joining component, enabling the electrical connector to be joined with the joining component. Therefore, the present application effectively addresses technical challenges where small-sized electrical connectors in an electrical connector joining component assembly have difficulty being joined with joining components. This allows the electrical connector joining component assembly and electrical connector thereof to be miniaturized, thereby enabling electronic devices incorporating the electrical connector joining component assembly and electrical connector thereof to continue advancing towards thinner and more compact designs.

### CROSS-REFERENCE TO RELATED APPLICATIONS

This application claims the priority of Republic of China Patent Application No. 113110911 filed on Mar. 22, 2024, in the State Intellectual Property Office of the R.O.C., the disclosure of which is incorporated herein by reference.

### BACKGROUND OF THE INVENTION

### Field of the Invention

The present application relates to the technical field of electronic devices, and more specifically, to an electrical connector joining component assembly and electrical connector thereof, which are applicable for small-sized designs.

### Descriptions of the Related Art

An electrical connector can join a joining component to form an electrical connector joining component assembly for signal transmission. In recent years, such electrical connector joining component assemblies have been widely used in various electronic devices.

However, with the trend of miniaturization in electronic devices, the internal space of electronic devices has been significantly reduced, forcing a reduction in the size of electrical connectors and joining components. As a result, it may become difficult for the electrical connector to properly join the joining component, thereby compromising the intended signal transmission functionality of the electrical connector joining component assembly.

In view of the foregoing, how to provide a small-sized electrical connector joining component assembly to address the technical issues such as the difficulty in joining the electrical connector with the joining component has become an urgent challenge for professionals in the relevant technical field.

### SUMMARY OF THE INVENTION

In view of the drawbacks of the prior art mentioned above, the present application provides an electrical connector, wherein the electrical connector is joined with a joining component, wherein the joining component comprises a joining component body joining guiding structure and a joining component body joining space, the electrical connector comprises: an electrical connector conductive terminal, wherein the electrical connector conductive terminal comprises an electrical connector terminal joining structure; and an electrical connector body, wherein the electrical connector body comprises an electrical connector body joining guiding structure and an electrical connector body joining observation structure; wherein the electrical connector body is mated with the electrical connector conductive terminal such that the electrical connector terminal joining structure is exposed; and the electrical connector body joining observation structure is adjacent to the electrical connector body joining guiding structure, such that during the process of the electrical connector being joined with the joining component, the electrical connector body joining observation structure allows for the observation of the relative position of the electrical connector body joining guiding structure and the joining component body joining guiding structure, thereby enabling real-time adjustment of the position of the electrical connector body, so that the electrical connector body joining guiding structure can align with the joining component body joining guiding structure, thereby guiding the electrical connector body into the joining component body joining space, enabling the electrical connector terminal joining structure to be joined with the joining component.

Preferably, the electrical connector said above, wherein the electrical connector body further comprises an electrical connector body insulation core, wherein the electrical connector body joining guiding structure and the electrical connector body joining observation structure are respectively disposed on the electrical connector body insulation core.

Preferably, the electrical connector said above, wherein the electrical connector body further comprises an electrical connector body metal shell, wherein the electrical connector body joining guiding structure and the electrical connector body joining observation structure are respectively disposed on the electrical connector body metal shell.

Preferably, the electrical connector said above, wherein the electrical connector body joining observation structure is a perforated structure extending along the outer contour of the electrical connector body joining guiding structure, so that the electrical connector body joining observation structure allows for the observation of the outer contour of the electrical connector body joining guiding structure.

Preferably, the electrical connector said above, wherein the electrical connector body joining guiding structure comprises an electrical connector body joining guiding wall, wherein the electrical connector body joining guiding wall extends in at least one direction, such that during the process of the electrical connector being joined with the joining component, the electrical connector body joining observation structure allows for the observation of the position of the electrical connector body joining guiding wall in at least one direction.

Preferably, the electrical connector said above, wherein the electrical connector body joining guiding structure enters the joining component body joining space, thereby guiding the electrical connector terminal joining structure to be joined with the joining component.

Additionally, the present application provides an electrical connector joining component assembly, wherein the electrical connector joining component assembly comprises: a joining component, wherein the joining component comprises: a joining component conductive terminal, wherein the joining component conductive terminal comprises a joining component terminal joining structure; and a joining component body, wherein the joining component body comprises a joining component body joining guiding structure and a joining component body joining space, wherein the joining component body is mated with the joining component conductive terminal such that the joining component terminal joining structure is exposed; and an electrical connector, wherein the electrical connector comprises: an electrical connector conductive terminal, wherein the electrical connector conductive terminal comprises an electrical connector terminal joining structure; and an electrical connector body, wherein the electrical connector body comprises an electrical connector body joining guiding structure and an electrical connector body joining observation structure, wherein the electrical connector body is mated with the electrical connector conductive terminal such that the electrical connector terminal joining structure is exposed; wherein the joining component body joining space is adjacent to the joining component body joining guiding structure, and the electrical connector body joining observation structure is adjacent to the electrical connector body joining guiding structure, such that during the process of the electrical connector being joined with the joining component, the electrical connector body joining observation structure allows for the observation of the relative position of the electrical connector body and the joining component body joining space, enabling real-time adjustment of the position of the electrical connector body to align with the joining component body joining space, and the electrical connector body joining observation structure allows for the observation of the relative position of the electrical connector body joining guiding structure and the joining component body joining guiding structure, thereby allowing the electrical connector body joining guiding structure to align with the joining component body joining guiding structure, guiding the electrical connector body into the joining component body joining space, enabling the electrical connector terminal joining structure to be joined with the joining component terminal joining structure.

Preferably, the electrical connector joining component assembly said above, wherein the joining component body further comprises a joining component body insulation core, wherein the joining component body joining guiding structure and the joining component body joining space are respectively disposed on the joining component body insulation core.

Preferably, the electrical connector joining component assembly said above, wherein the joining component body further comprises a joining component body metal shell, wherein the joining component body joining guiding structure and the joining component body joining space are respectively disposed on the joining component body metal shell.

Preferably, the electrical connector joining component assembly said above, wherein the joining component body joining space comprises a joining component body joining guiding subspace, wherein the electrical connector body joining guiding structure enters the joining component body joining guiding subspace to contact the joining component body joining guiding structure, thereby guiding the electrical connector terminal joining structure to be joined with the joining component terminal joining structure.

Preferably, the electrical connector joining component assembly said above, wherein the joining component body joining guiding structure comprises a frame-like structure extending around the joining component body joining guiding subspace, providing guidance for the electrical connector body joining guiding structure to enter the joining component body joining guiding subspace.

Preferably, the electrical connector joining component assembly said above, wherein the joining component body joining guiding structure comprises a joining component body joining guiding wall, wherein the joining component body joining guiding wall extends in at least one direction, such that during the process of the electrical connector being joined with the joining component, the electrical connector body joining observation structure allows for the observation of the position of the joining component body joining guiding wall in at least one direction.

Compared with the prior art, the present application provides an electrical connector joining component assembly and electrical connector thereof, wherein the electrical connector is joined with a joining component and comprises a joining observation structure. During the process in which the electrical connector is joined with the joining component, the joining observation structure allows for visual observation of the joining component, thereby enabling real-time adjustment of the electrical connector's position to ensure alignment with the joining component, enabling the electrical connector to be joined with the joining component. Therefore, the present application effectively addresses technical challenges where small-sized electrical connectors in an electrical connector joining component assembly have difficulty being joined with joining components. This allows the electrical connector joining component assembly and electrical connector thereof to be miniaturized, thereby enabling electronic devices incorporating the electrical connector joining component assembly and electrical connector thereof to continue advancing towards thinner and more compact designs.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective schematic view of a first viewing angle of an electrical connector joining component assembly in an embodiment of the present application.

FIG. 2 is a perspective schematic view of a second viewing angle of an electrical connector joining component assembly in an embodiment of the present application.

FIG. 3 is a perspective schematic view of a first viewing angle of an electrical connector joining component assembly in an embodiment of the present application.

FIG. 4 is a perspective schematic view of a second viewing angle of an electrical connector joining component assembly in an embodiment of the present application.

FIG. 5 is a perspective schematic view of a first viewing angle of an electrical connector joining component assembly in an embodiment of the present application.

FIG. 6 is a perspective schematic view of a second viewing angle of an electrical connector joining component assembly in an embodiment of the present application.

FIG. 7 is a perspective schematic view of a first viewing angle of an electrical connector joining component assembly in an embodiment of the present application.

FIG. 8 is a perspective schematic view of a second viewing angle of an electrical connector joining component assembly in an embodiment of the present application.

FIG. 9 is a top view schematic of an electrical connector joining component assembly in an embodiment of the present application.

FIG. 10 is a bottom view schematic of an electrical connector joining component assembly in an embodiment of the present application.

FIG. 11 is a top view schematic of an electrical connector joining component assembly in an embodiment of the present application.

FIG. 12 is a bottom view schematic of an electrical connector joining component assembly in an embodiment of the present application.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

The present application provides an electrical connector joining component assembly and electrical connector thereof, wherein the electrical connector is capable of joining with a joining component and comprises a joining observation structure. The joining observation structure allows for the observation of the joining component, thereby enabling the electrical connector to be aligned with the joining component to facilitate joining. Therefore, the present application is applicable to small-sized electrical connector joining component assemblies, addressing technical challenges such as the difficulty in joining small-sized electrical connectors with small-sized joining components.

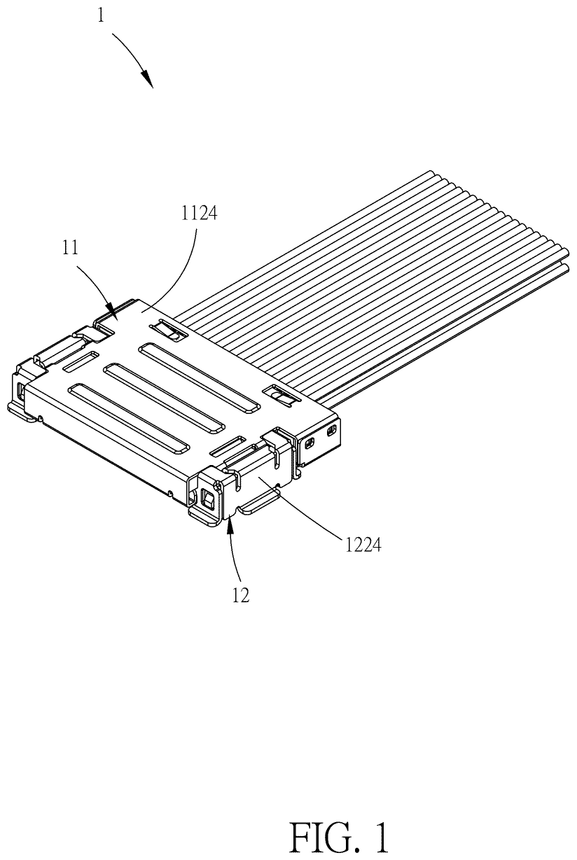

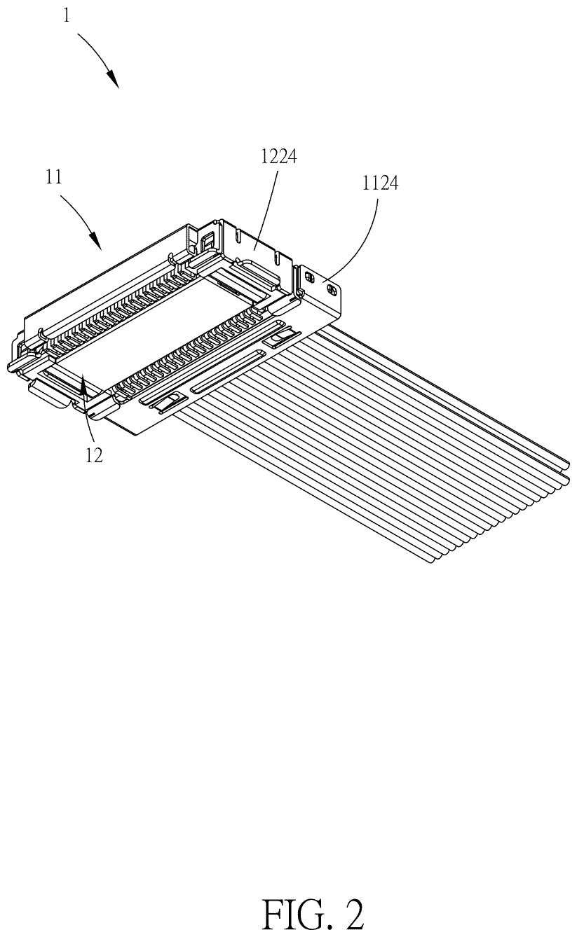

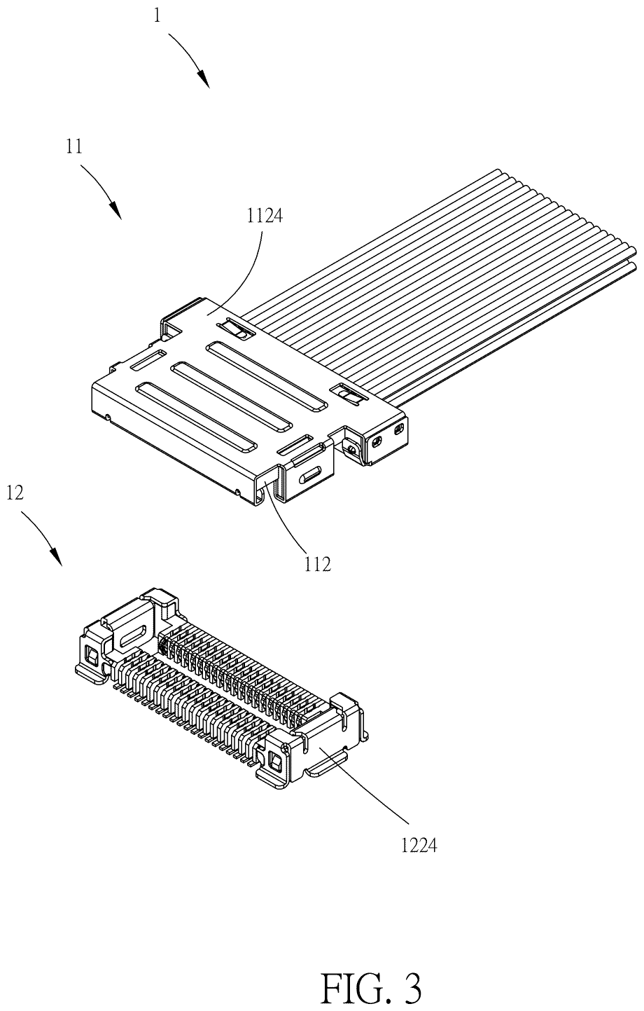

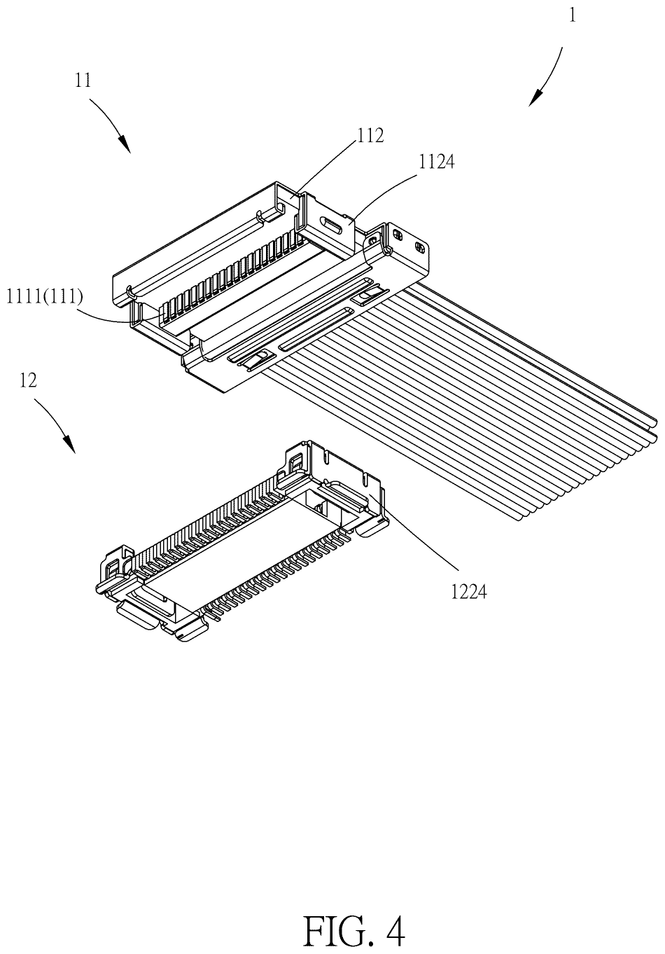

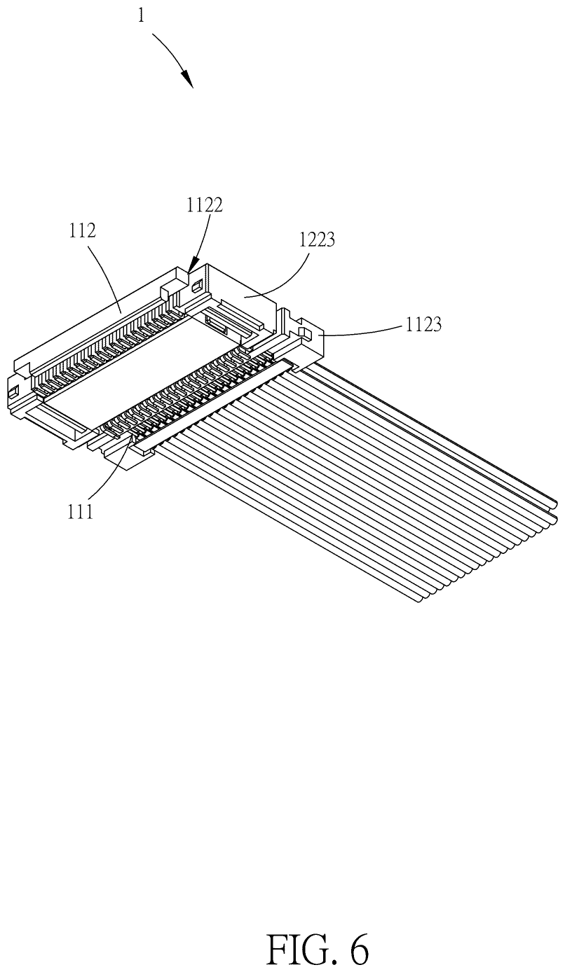

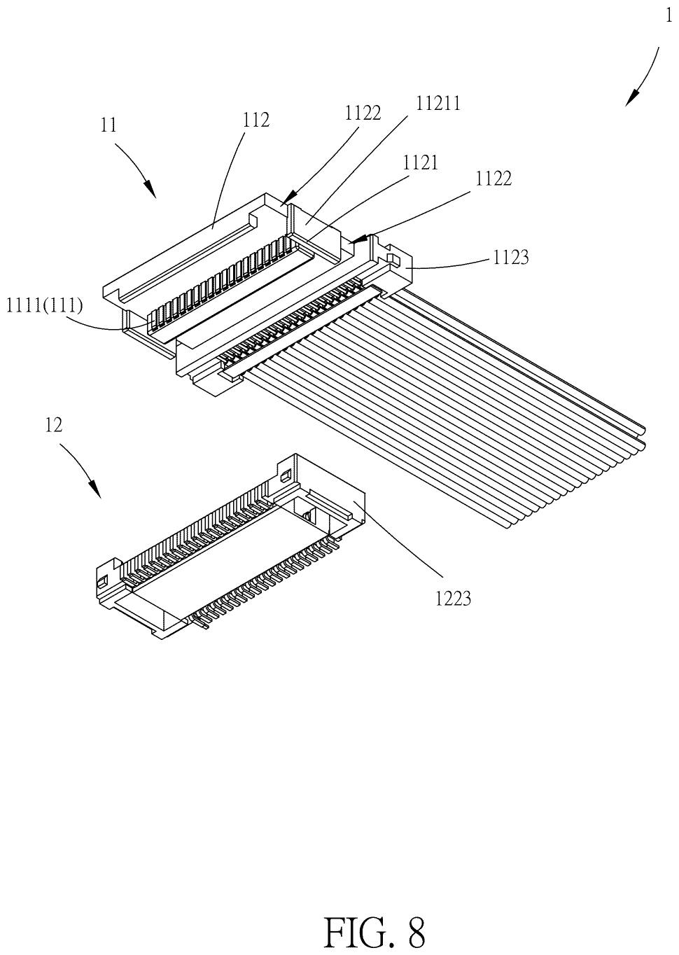

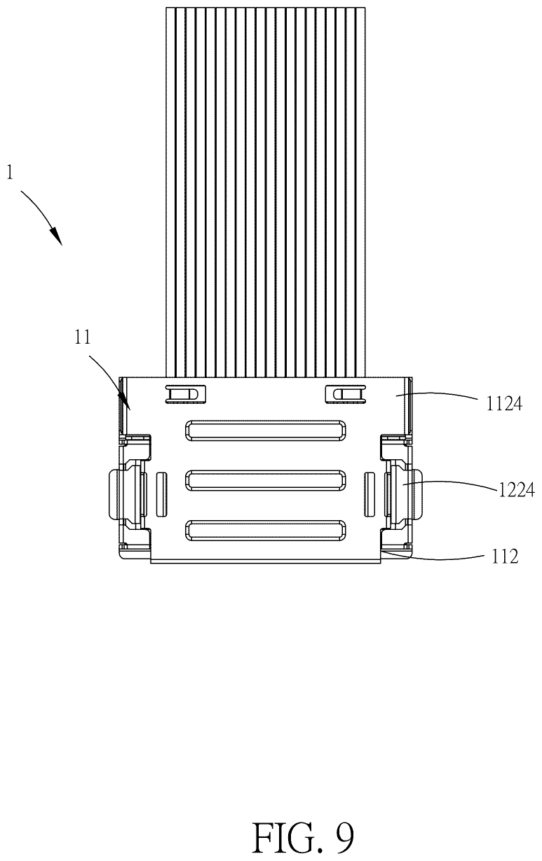

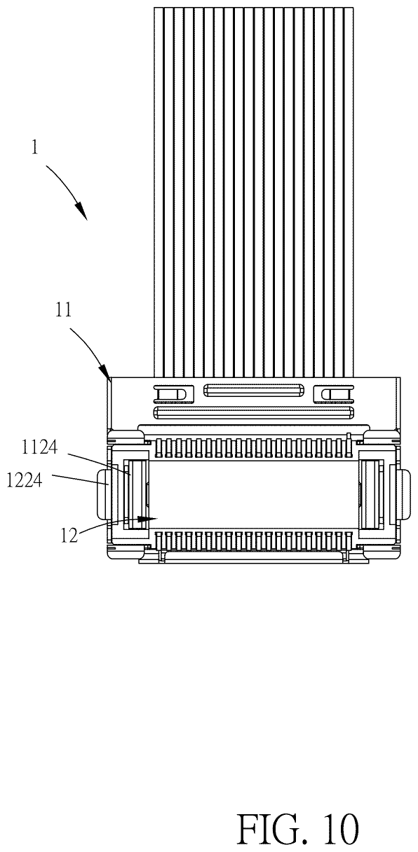

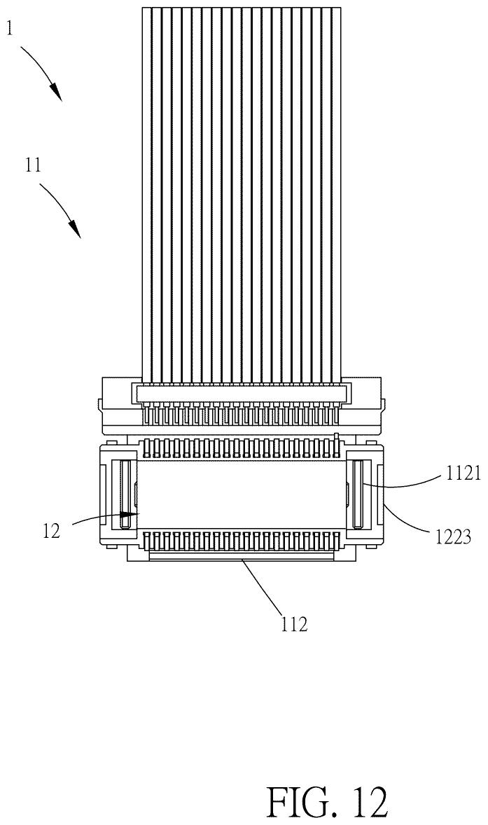

For a detailed description of the embodiments disclosed in the present application, please refer to FIGS. 1 to 12.

As shown in FIGS. 1 to 12, an electrical connector joining component assembly 1 is provided, which comprises an electrical connector 11 and a joining component 12. The electrical connector 11 can join the joining component 12 to transmit electrical signals. The joining component 12 can be in the form of conductive terminals or electrical connectors.

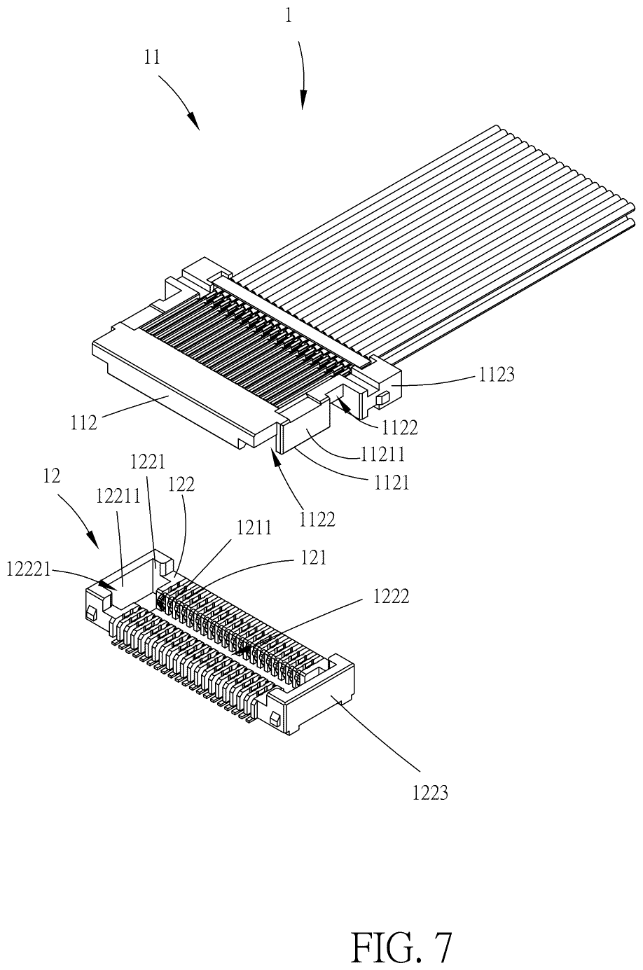

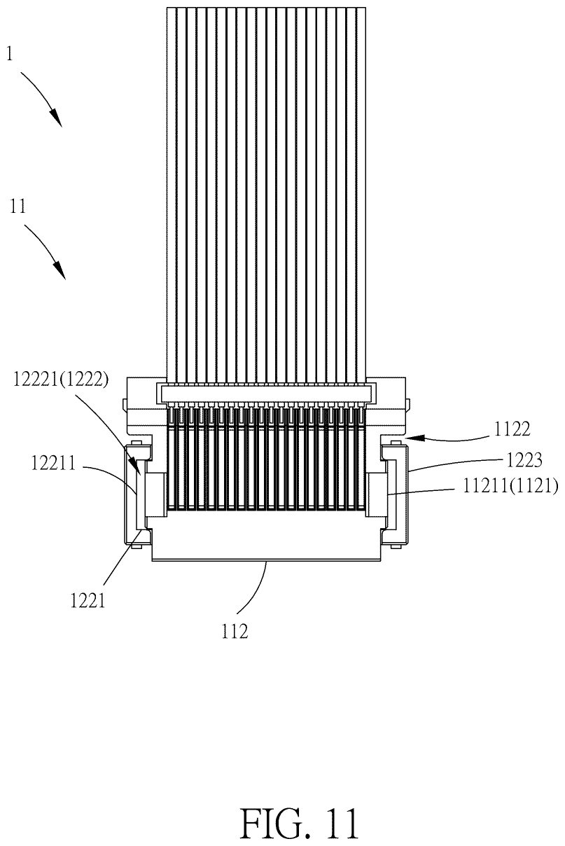

The joining component 12 comprises a joining component conductive terminal 121 and a joining component body 122. The joining component conductive terminal 121 comprises a joining component terminal joining structure 1211. The joining component body 122 comprises a joining component body joining guiding structure 1221 and a joining component body joining space 1222. Additionally, the joining component body 122 can be mated with the joining component conductive terminal 121 such that the joining component terminal joining structure 1211 is exposed. In the aforementioned embodiment, as illustrated in FIGS. 7 and 11, the joining component body joining space 1222 comprises a joining component body joining guiding subspace 12221.

The electrical connector 11 may optionally be an LVDS electrical connector. The electrical connector 11 comprises an electrical connector conductive terminal 111 and an electrical connector body 112. The electrical connector conductive terminal 111 comprises an electrical connector terminal joining structure 1111. Correspondingly, the electrical connector body 112 comprises an electrical connector body joining guiding structure 1121 and an electrical connector body joining observation structure 1122. Additionally, the electrical connector body 112 can be mated with the electrical connector conductive terminal 111 such that the electrical connector terminal joining structure 1111 is exposed.

It should be noted that, in the aforementioned embodiments, the electrical connector body joining observation structure 1122 is adjacent to the electrical connector body joining guiding structure 1121, allowing the electrical connector body joining observation structure 1122 and the electrical connector body joining guiding structure 1121 to be visually observed with each other. Similarly, the joining component body joining space 1222 is adjacent to the joining component body joining guiding structure 1221, enabling the joining component body joining space 1222 and the joining component body joining guiding structure 1221 to be visually observed with each other. Thus, when the electrical connector 11 joins the joining component 12, the electrical connector body joining observation structure 1122 enables real-time visual observation of the relative position between the electrical connector body 112 and the joining component body joining space 1222, thereby allowing real-time adjustments to the position of the electrical connector body 112 to ensure alignment with the joining component body joining space 1222. The electrical connector body joining observation structure 1122 can also be used to visually observe the relative position between the electrical connector body joining guiding structure 1121 and the joining component body joining guiding structure 1221, facilitating the alignment of the electrical connector body joining guiding structure 1121 with the joining component body joining guiding structure 1221 and guiding the electrical connector body 112 into the joining component body joining space 1222. Consequently, the electrical connector terminal joining structure 1111 can join the joining component terminal joining structure 1211 to provide signal transmission. This design effectively reduces resistance during the joining of the conductive terminals, preventing improper joining or deformation of the electrical connector terminal joining structure 1111 and the joining component terminal joining structure 1211, thereby enhancing the reliability of the electrical connector joining component assembly 1 and the electrical connector 11 thereof.

Additionally, the joining component body joining guiding structure 1221 is a frame-like structure extending around the joining component body joining guiding subspace 12221, which facilitates the guidance of the electrical connector body joining guiding structure 1121 into the joining component body joining guiding subspace 12221 or the joining component body joining space 1222, thereby making contact with the joining component body joining guiding structure 1221 and guiding the electrical connector terminal joining structure 1111 to join the joining component terminal joining structure 1211.

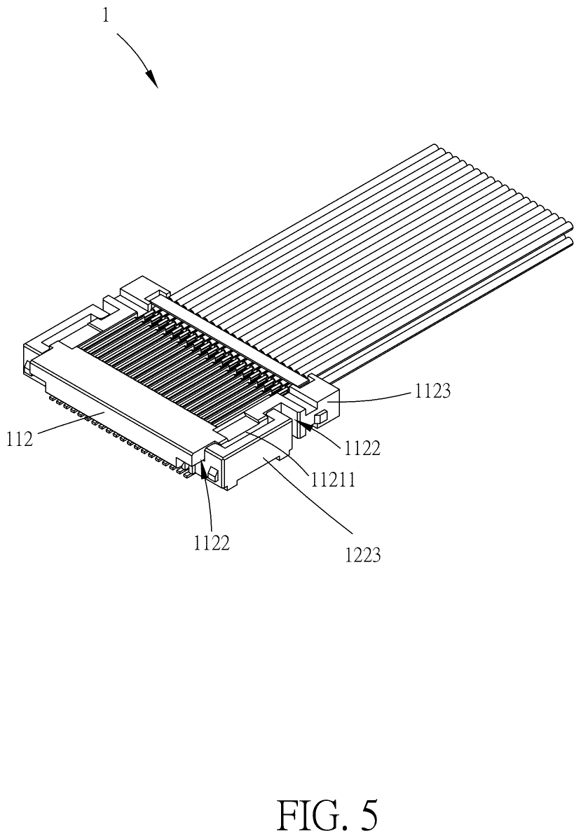

As illustrated in FIGS. 5 to 8 and FIG. 11, the electrical connector body joining observation structure 1122 is a perforated structure extending along the outer contour of the electrical connector body joining guiding structure 1121, enabling the visual observation of the outer contour of the electrical connector body joining guiding structure 1121 and the relative position between the electrical connector body joining guiding structure 1121 and the joining component body joining guiding structure 1221.

Additionally, the joining component body joining guiding structure 1221 comprises a joining component body joining guiding wall 12211, which extends in at least one direction. When the electrical connector 11 joins the joining component 12, the electrical connector body joining observation structure 1122 allows for visual observation of the position of the joining component body joining guiding wall 12211 in at least one direction, thereby enabling visual observation of the relative position between the electrical connector body joining guiding structure 1121 and the joining component body joining guiding structure 1221.

As illustrated in FIGS. 5, 7, 8, and 11, the electrical connector body joining guiding structure 1121 comprises an electrical connector body joining guiding wall 11211, which extends in at least one direction. When the electrical connector 11 joins the joining component 12, the electrical connector body joining observation structure 1122 allows for visual observation of the electrical connector body joining guiding wall 11211 in at least one direction, thereby enabling visual observation of the relative position between the electrical connector body joining guiding structure 1121 and the joining component body joining guiding structure 1221.

In the embodiments illustrated in FIGS. 5 to 8 and FIGS. 11 to 12, the electrical connector body 112 further comprises an electrical connector body insulation core 1123, and the joining component body 122 further comprises a joining component body insulation core 1223. Accordingly, in the aforementioned embodiments, the electrical connector body joining guiding structure 1121 and the electrical connector body joining observation structure 1122 are respectively disposed on the electrical connector body insulation core 1123, while the joining component body joining guiding structure 1221 and the joining component body joining space 1222 are respectively disposed on the joining component body insulation core 1223.

In the embodiments illustrated in FIGS. 1 to 4 and FIGS. 9 to 10, the electrical connector body 112 is further provided with an electrical connector body metal shell 1124, and the joining component body 122 is further provided with a joining component body metal shell 1224. Accordingly, in the aforementioned embodiments, the electrical connector body joining guiding structure 1121 and the electrical connector body joining observation structure 1122 are respectively disposed on the electrical connector body metal shell 1124, while the joining component body joining guiding structure 1221 and the joining component body joining space 1222 are respectively disposed on the joining component body metal shell 1224.

It should be noted that the electrical connector joining component assembly and electrical connector thereof in the present application may omit certain components and are not limited to the above embodiments.

For example, the electrical connector in the present application may optionally comprise only an electrical connector conductive terminal and an electrical connector body. The electrical connector conductive terminal comprises an electrical connector terminal joining structure. The electrical connector body comprises an electrical connector body joining guiding structure and an electrical connector body joining observation structure. The electrical connector body can be mated with the electrical connector conductive terminal to expose the electrical connector terminal joining structure. Additionally, the electrical connector body joining observation structure is adjacent to the electrical connector body joining guiding structure, allowing the electrical connector body joining observation structure to observe the relative position between the electrical connector body joining guiding structure and the joining component body joining guiding structure during the joining process between the electrical connector and the joining component. This enables real-time adjustment of the electrical connector body position, ensuring that the electrical connector body joining guiding structure is aligned with the joining component body joining guiding structure, thereby guiding the electrical connector body into the joining component body joining space and allowing the electrical connector terminal joining structure to join the joining component.

Additionally, the electrical connector joining component assembly in the present application may optionally comprise only a joining component and an electrical connector. The joining component comprises a joining component conductive terminal and a joining component body. The joining component conductive terminal comprises a joining component terminal joining structure, while the joining component body comprises a joining component body joining guiding structure and a joining component body joining space. The joining component body can be mated with the joining component conductive terminal to expose the joining component terminal joining structure. The electrical connector comprises an electrical connector conductive terminal and an electrical connector body. The electrical connector conductive terminal comprises an electrical connector terminal joining structure, while the electrical connector body comprises an electrical connector body joining guiding structure and an electrical connector body joining observation structure. The electrical connector body can be mated with the electrical connector conductive terminal to expose the electrical connector terminal joining structure. In this configuration, the joining component body joining space is adjacent to the joining component body joining guiding structure, and the electrical connector body joining observation structure is adjacent to the electrical connector body joining guiding structure. During the joining process between the electrical connector and the joining component, the electrical connector body joining observation structure enables real-time observation of the relative position between the electrical connector body and the joining component body joining space. This allows real-time adjustment of the electrical connector body position to ensure alignment with the joining component body joining space. Additionally, the electrical connector body joining observation structure can observe the relative position between the electrical connector body joining guiding structure and the joining component body joining guiding structure, ensuring alignment and guiding the electrical connector body into the joining component body joining space, thereby enabling the electrical connector terminal joining structure to join the joining component terminal joining structure.

In summary, the present application provides an electrical connector joining component assembly and electrical connector thereof, wherein the electrical connector is capable of joining with a joining component and comprises a joining observation structure. During the joining process between the electrical connector and the joining component, the joining observation structure enables real-time visual observation of the joining component, allowing for real-time adjustment of the electrical connector's position. This ensures that the electrical connector can be properly aligned with the joining component to facilitate joining. Therefore, the present application effectively addresses technical challenges such as the difficulty in joining small-sized electrical connectors with joining components. It also enables the miniaturization of the electrical connector joining component assembly and electrical connector thereof, facilitating the continued trend toward thinner and more compact electronic devices that incorporate the electrical connector joining component assembly and electrical connector thereof.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. An electrical connector, wherein the electrical connector is joined with a joining component, wherein the joining component comprises a joining component body joining guiding structure and a joining component body joining space, the electrical connector comprises:
an electrical connector conductive terminal, wherein the electrical connector conductive terminal comprises an electrical connector terminal joining structure; and
an electrical connector body, wherein the electrical connector body comprises an electrical connector body joining guiding structure and an electrical connector body joining observation structure; wherein the electrical connector body is mated with the electrical connector conductive terminal such that the electrical connector terminal joining structure is exposed; and
the electrical connector body joining observation structure is adjacent to the electrical connector body joining guiding structure, such that during the process of the electrical connector being joined with the joining component, the electrical connector body joining observation structure allows for the observation of the relative position of the electrical connector body joining guiding structure and the joining component body joining guiding structure, thereby enabling real-time adjustment of the position of the electrical connector body, so that the electrical connector body joining guiding structure can align with the joining component body joining guiding structure, thereby guiding the electrical connector body into the joining component body joining space, enabling the electrical connector terminal joining structure to be joined with the joining component.

2. The electrical connector of claim 1, wherein the electrical connector body further comprises an electrical connector body insulation core, wherein the electrical connector body joining guiding structure and the electrical connector body joining observation structure are respectively disposed on the electrical connector body insulation core.

3. The electrical connector of claim 1, wherein the electrical connector body further comprises an electrical connector body metal shell, wherein the electrical connector body joining guiding structure and the electrical connector body joining observation structure are respectively disposed on the electrical connector body metal shell.

4. The electrical connector of claim 1, wherein the electrical connector body joining observation structure is a perforated structure extending along the outer contour of the electrical connector body joining guiding structure, so that the electrical connector body joining observation structure allows for the observation of the outer contour of the electrical connector body joining guiding structure.

5. The electrical connector of claim 1, wherein the electrical connector body joining guiding structure comprises an electrical connector body joining guiding wall, wherein the electrical connector body joining guiding wall extends in at least one direction, such that during the process of the electrical connector being joined with the joining component, the electrical connector body joining observation structure allows for the observation of the position of the electrical connector body joining guiding wall in at least one direction.

6. The electrical connector of claim 1, wherein the electrical connector body joining guiding structure enters the joining component body joining space, thereby guiding the electrical connector terminal joining structure to be joined with the joining component.

7. An electrical connector joining component assembly, wherein the electrical connector joining component assembly comprises:
a joining component, wherein the joining component comprises:
a joining component conductive terminal, wherein the joining component conductive terminal comprises a joining component terminal joining structure; and
a joining component body, wherein the joining component body comprises a joining component body joining guiding structure and a joining component body joining space, wherein the joining component body is mated with the joining component conductive terminal such that the joining component terminal joining structure is exposed; and
an electrical connector, wherein the electrical connector comprises:
an electrical connector conductive terminal, wherein the electrical connector conductive terminal comprises an electrical connector terminal joining structure; and
an electrical connector body, wherein the electrical connector body comprises an electrical connector body joining guiding structure and an electrical connector body joining observation structure, wherein the electrical connector body is mated with the electrical connector conductive terminal such that the electrical connector terminal joining structure is exposed; wherein
the joining component body joining space is adjacent to the joining component body joining guiding structure, and the electrical connector body joining observation structure is adjacent to the electrical connector body joining guiding structure, such that during the process of the electrical connector being joined with the joining component, the electrical connector body joining observation structure allows for the observation of the relative position of the electrical connector body and the joining component body joining space, enabling real-time adjustment of the position of the electrical connector body to align with the joining component body joining space, and the electrical connector body joining observation structure allows for the observation of the relative position of the electrical connector body joining guiding structure and the joining component body joining guiding structure, thereby allowing the electrical connector body joining guiding structure to align with the joining component body joining guiding structure, guiding the electrical connector body into the joining component body joining space, enabling the electrical connector terminal joining structure to be joined with the joining component terminal joining structure.

8. The electrical connector joining component assembly of claim 7, wherein the joining component body further comprises a joining component body insulation core, wherein the joining component body joining guiding structure and the joining component body joining space are respectively disposed on the joining component body insulation core.

9. The electrical connector joining component assembly of claim 7, wherein the joining component body further comprises a joining component body metal shell, wherein the joining component body joining guiding structure and the joining component body joining space are respectively disposed on the joining component body metal shell.

10. The electrical connector joining component assembly of claim 7, wherein the joining component body joining space comprises a joining component body joining guiding subspace, wherein the electrical connector body joining guiding structure enters the joining component body joining guiding subspace to contact the joining component body joining guiding structure, thereby guiding the electrical connector terminal joining structure to be joined with the joining component terminal joining structure.

11. The electrical connector joining component assembly of claim 10, wherein the joining component body joining guiding structure comprises a frame-like structure extending around the joining component body joining guiding subspace, providing guidance for the electrical connector body joining guiding structure to enter the joining component body joining guiding subspace.

12. The electrical connector joining component assembly of claim 7, wherein the joining component body joining guiding structure comprises a joining component body joining guiding wall, wherein the joining component body joining guiding wall extends in at least one direction, such that during the process of the electrical connector being joined with the joining component, the electrical connector body joining observation structure allows for the observation of the position of the joining component body joining guiding wall in at least one direction.
